(19) United States
(12) Patent Application Publication
(10) Pub. No.: US 2007/0135541 A1
(43) Pub. Date: Jun. 14, 2007

(54) THERMOPLASTIC OLEFIN COMPOSITIONS FOR HOOK-AND-LOOP FASTENER APPLICATIONS

(75) Inventors: Deenadayalu Chundury, Newburgh, IN (US); Theophilus McGee, Mt. Carmel, IL (US); Ann Mendel, Evansville, IN (US); Brian Keener, Sugar Land, TX (US); Benjamin A. Jones, Evansville, IN (US)

Correspondence Address: RANKIN, HILL, PORTER & CLARK, LLP, 925 EUCLID AVENUE, SUITE 700, CLEVELAND, OH, 44115-1405, US

(73) Assignee: FERRO CORPORATION, Cleveland, OH (US)

(21) Appl. No.: 11/164,904

(22) Filed: Dec. 9, 2005

(51) Int. Cl. C08K 5/524

(52) U.S. Cl. 524/128; 524/425; 524/431; 524/251; 524/250; 524/394; 524/515

(57) ABSTRACT

The present invention provides a thermoplastic olefin composition that is particularly suitable for use in extruding tapes or films that can be further processed to form the hook portion of hook-and-loop fasteners for use on disposable absorbent products. The thermoplastic olefin compositions according to the invention provide the opacity, tear strength and flexural modulus considered optimal for such applications. Thermoplastic olefin compositions according to the invention include an olefin component including a highly crystalline homopolymer of polypropylene, an inorganic particulate filler component, and a colorant package including titanium dioxide and iron oxide pigments.

### FIELD OF INVENTION

The present invention relates to thermoplastic olefin compositions and a hook-and-loop fastener component made thereof. More particularly, the present invention relates to thermoplastic olefin compositions that provide the opacity, flexural modulus and tear strength required for the hook portion of hook-and-loop fasteners.

### DESCRIPTION OF RELATED ART

Hook-and-loop fasteners are used in a variety of applications including, for example, to releasably secure disposable absorbent products such as diapers and adult incontinence products on humans. Leak et al., U.S. Pat. App. Pub. 2003/0100878 A1, for example, discloses a mechanical fastening tab that includes a plurality of hooks adapted to releasably engage with loop material, which can be attached to or comprise the outer surface of a disposable absorbent product.

When used to secure disposable absorbent products on humans, the hook portion of such fastening tabs must have sufficient stiffness and tear strength to releasably engage with the loop portion of the fastener, while at the same time exhibit sufficient flexibility to provide comfort to the wearer. If the hook portion does not have sufficient stiffness, the fastener may not stay engaged with the loop material thereby allowing the disposable absorbent product to become unsecured from the human. If the hook portion does not have sufficient tear strength, the fastening tab may tear into two pieces thereby prohibiting reengagement of the fastening tab with the loop material. If the hook portion is too stiff, the fastening tab can present comfort issues.

The fastening tab portion comprises a plurality of hooks that are typically formed using a calendaring process in which a strip of extruded thermoplastic tape or film is processed using heat and pressure to form the hooks. It would be desirable to be able to monitor the thickness of the thermoplastic tape or film by taking measurements of the amount of light passing through it. Efforts to use conventional opacifying additives such as titanium dioxide and other inorganic particulate materials to control the opacity of such extruded tapes and films have been largely unsuccessful. The presence of sufficient quantities of such opacifying materials in the thermoplastic compositions has resulted in a degradation of the mechanical properties of the thermoplastic composition and/or has created other adverse processing issues such as undesirable build-up of material on the extrusion dies. Prior art thermoplastic compositions could not control opacity within a specified range of opacity (e.g., 70-105 gray scale) and provide sufficient tear strength and a minimum of 300,000 psi flexural modulus.

### BRIEF SUMMARY OF THE INVENTION

The present invention provides a thermoplastic olefin composition that is particularly suitable for use in extruding tapes or films that can be further processed to form the hook portion of hook-and-loop fasteners for use on disposable absorbent products. The thermoplastic olefin composition according to the invention provides the opacity, tear strength and flexural modulus considered optimal for such applications. Thermoplastic olefin compositions according to the invention comprise an olefin component comprising a highly crystalline homopolymer of polypropylene, an inorganic particulate filler component, and a colorant package comprising titanium dioxide and iron oxide pigments.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

Thermoplastic olefin compositions according to the invention comprise an olefin component, an inorganic particulate filler component, and a colorant package. The olefin component comprises from about 65% to about 95% by weight, and more preferably from about 70% to about 80% by weight of the composition. The olefin component comprises at least a highly crystalline polypropylene homopolymer. Throughout the instant specification and in the appended claims, the term “highly crystalline polypropylene homopolymer” refers to a homopolymer of polypropylene having a crystallization temperature (T_{c}) of ≧120° C. and a flexural modulus≧300,000 psi. More preferably, the olefin component comprises a blend of at least one highly crystalline polypropylene homopolymer and at least one general purpose polypropylene homopolymer, provided that the melt flow index ratio of the highly crystalline polypropylene homopolymer to the general purpose polypropylene homopolymer is not greater than 3:1, and the flexural modulus of the blend is ≧2200,000 psi.

The inorganic particulate filler component preferably comprises from about 5% to about 35% by weight, and more preferably from about 15% to about 35% by weight, of talc, calcium carbonate, glass beads or other conventional mineral fillers used in thermoplastic olefin compositions. Calcium carbonate is the presently most preferred inorganic filler for use in the invention. Preferably, the calcium carbonate is coated with a fatty acid such as stearic acid, which is converted to calcium stearate during processing. The inorganic particulate filler should have a particle size within the range of from about 1 μm to about 5 μm.

The colorant package must comprise at least titanium dioxide and iron oxide pigments. The colorant package preferably comprises from about 2.5% to about 12.5% by weight, and more preferably from about 4% to about 10% by weight, of the composition. The titanium dioxide portion of the colorant package, by itself, preferably comprises from about 2% to about 10% by weight, and more preferably, from about 2% to about 6% by weight, of the composition. The iron oxide pigments portion of the colorant package, by itself, preferably comprises from about 0.001% to about 3% by weight, and more preferably from about 0.01% to about 0.5% by weight, of the composition.

If a light pastel pink or blue color is desired, e.g., for the hook portion of hook and loop type fastening tabs used in baby diaper applications, the colorant package can further comprise one or more additional pigments such as, for example, ultramarine-based colorants, diketo-pyrrolo-pyrrole red and V11633 kelly green pigments. The additional pigments are preferably present in amounts ranging from about 0.5% to about 5% by weight, and more preferably, from about 2% to about 4% by weight of the composition. The components comprising the colorant package can be blended together, optionally with other additives, and added to the olefin component as a masterbatch, or they can be added separately to the composition.

The thermoplastic olefin compositions according to the present invention further preferably comprise from about 0.05% to about 0.3% by weight, and more preferably from about 0.1% to about 0.25% by weight, of one or more nucleating agents. Suitable nucleating agents include, for example, sorbitol, sodium benzoate and phosphate esters. Nucleating agents help improve and/or maintain the crystallization temperature (T_{c}), the flexural modulus, the tensile strength and/or the heat distortion temperature of the resulting composition. The thermoplastic olefin compositions according to the present invention can further optionally comprise all additives conventionally used in olefin compositions including, for example, antioxidants, lubricants, stabilizers and the like.

The presently most preferred thermoplastic olefin composition according to the invention comprises: about 71% to about 75% by weight, and more preferably about 72.5% by weight, of an olefin component comprising a 60:40 to 40:60 by weight blend of a general purpose homopolymer of polypropylene and a highly crystalline homopolymer of polypropylene; about 15% to about 25%, and more preferably about 20% by weight, of an inorganic particulate filler comprising calcium carbonate, which is preferably coated with a fatty acid such as stearic acid; about 0.05% to about 0.15% by weight, and more preferably about 0.10% by weight, of a sorbitol nucleating agent; about 0.10% to about 0.20% by weight, and more preferably about 0.15% by weight, of a hindered phenolic antioxidant package; about 0.01% to about 0.10% by weight, and more preferably about 0.05% by weight, of an organic phosphite process stabilizer; about 0.10% to about 0.20% by weight, and more preferably about 0.15% by weight, of a calcium stearate process aid; about 0.10% to about 0.20% by weight, and more preferably about 0.15% by weight, of an ethylene bis-stearamide lubricant; and about 6% to about 8% by weight, and more preferably about 7% by weight of a colorant package comprising titanium dioxide, iron oxide, and any other desired colorants in the amounts specified above to obtain a white, blue, pink or other color in the amounts previously specified above. The thermoplastic olefin composition according to the invention advantageously provides a consistent degree of opacity, which allows for in-line monitoring of tape thickness during hook and loop fastener fabrication.

The individual components comprising the thermoplastic olefin composition according to the invention can be melt blended together in an extruder and extruded as strands, which are cooled in a water bath, dried and chopped to form pellets. The pellets can then be used in conventional injection molding equipment to form parts or processed on conventional sheet or film extrusion equipment to form sheet, film or tape. The tape can be further processed, such as by calendaring, to form mechanical fastening tabs comprising the hook portion of hook-and-loop fasteners.

It will be appreciated that the thermoplastic olefin composition according to the invention can be used in other applications, including, for example, in automotive injection molding applications, various injection blow molding applications as well as extrusion blow molding applications.

The typical range of properties for thermoplastic olefin compositions according to the invention are: a melt flow, as determined in accordance with ASTM D1238-04 (“Standard Test Method for MELT Flow Rates of Thermoplastics by Extrusion Plastometer”), of about 18 to about 24 g/10 min; a notched Izod @ 23° C., as determined in accordance with ASTM Standard D256-03 (“Standard Test Methods for Determining the Izod Pendulum Impact Resistance of Plastics”), of about 0.5 to about 1.0 ft-lb/in; a tensile strength, as determined in accordance with ASTM D638-03 (“Standard Test Method for Tensile Properties of Plastics”), of about 2,800 to about 4,500 psi; and a flexural modulus, as determined in accordance with ASTM D790-03 (“Standard Test Methods for Flexural Properties of Unreinforced and Reinforced Plastics and Electrical Insulating Materials”), of greater than about 300,000 psi.

The following examples are intended only to illustrate the invention and should not be construed as imposing limitations upon the claims.

### EXAMPLE 1

Samples A through E were prepared by melt mixing the components shown in parts by weight in Table 1 below in a 2.5″ single-screw extruder at 150 rpm and extruding the melt-mixed material at 230° C. through a die to form strands, which were passed through a water bath, air wiped and then cut into pellets.

TABLE 1

| Component | Sample A | Sample B | Sample C | Sample D | Sample E |
|---|---|---|---|---|---|
| MARLEX HGX-120⁽¹⁾ | 75.4357 | 0.0 | 39.2857 | 46.23 | 36.26 |
| ACCPRO 9934⁽²⁾ | 0.0 | 72.2602 | 40.0 | 46.23 | 36.23 |
| SUPERCOAT⁽³⁾ | 20.0 | 20.0 | 5.0 | 0.0 | 20.0 |
| IRGACLEAR D⁽⁴⁾ | 0.10 | 0.30 | 0.10 | 0.10 | 0.10 |
| Vanox 898⁽⁵⁾ | 0.05 | 0.05 | 0.05 | 0.05 | 0.05 |
| IRGANOX B-225⁽⁶⁾ | 0.15 | 0.15 | 0.15 | 0.15 | 0.15 |
| Ethylene bis-stearamide Wax | 0.15 | 0.15 | 0.15 | 0.15 | 0.15 |
| Calcium Stearate | 0.15 | 0.15 | 0.15 | 0.15 | 0.15 |
| Ultramarine Blue | 0.0 | 2.9255 | 1.0 | 2.9255 | 2.9255 |
| Titanium Dioxide | 3.9 | 3.9 | 14 | 3.9 | 3.9 |
| Diketo-Pyrrolo-Pyrrole Red | 0.0036 | 0.0036 | 0.0036 | 0.0036 | 0.0036 |
| V11633 Kelly Green⁽⁷⁾ | 0.0607 | 0.0607 | 0.0607 | 0.0607 | 0.0607 |
| Iron Oxide (Black) | 0.0 | 0.0500 | 0.0500 | 0.0500 | 0.0500 |

Notes:
⁽¹⁾MARLEX HGX-120 is a general purpose polypropylene homopolymer available from Phillips-Sumika;
⁽²⁾ACCPRO 9934 is a highly crystalline polypropylene homopolymer available from Innovene;
⁽³⁾SUPERCOAT is calcium carbonate coated with stearic acid;
⁽⁴⁾IRGACLEAR D is a sorbitol based clarifying agent available from Ciba Specialty Chemicals, Inc.;
⁽⁵⁾Vanox 898 is an organic zinc stabilizer available from R.T. Vanderbilt Company, Inc.;
⁽⁶⁾IRGANOX B-225 is a thermal stabilizer consisting of a 50/50 blend of (tris(2,4-di-(tert)-butylphenyl) phosphite) and pentaerythritol tetrakis(3-(3,5 di-tert-butyl-4-hydroxyphenyl)propianate) available from Ciba Specialty Chemicals, Inc.;
⁽⁷⁾V11633 is an inorganic pigment available from Ferro Corporation.

### EXAMPLE 2

Pellets of Samples A through E were used to form the hook portion of hook and loop type fastening tabs typically used to secure disposable absorbent products to humans. The fastening tabs formed from Sample A had insufficient tear strength and did not form satisfactory hooks for use in such application. The fastening tabs formed from Sample B had insufficient ductility after ultrasonic welding to be suitable for use in such application. The fastening tabs formed from Sample C exhibited poor ductility after ultrasonic welding and produced undesirable die buildup. The fastening tabs formed from Sample D exhibited poor ductility after ultrasonic welding. The fastening tabs formed from Sample E, however, were acceptable in all respects. Sample E had a melt flow of 21 g/10 min as determined in accordance with ASTM D1238-04 (“Standard Test Method for MELT Flow Rates of Thermoplastics by Extrusion Plastometer”); a notched Izod @ 23° C. of 0.7 ft-lb/in as determined in accordance with ASTM Standard D256-03 (“Standard Test Methods for Determining the Izod Pendulum Impact Resistance of Plastics”); a tensile strength of 4,425 psi as determined in accordance with ASTM D638-03 (“Standard Test Method for Tensile Properties of Plastics”); and a flexural modulus of 360,475 psi as determined in accordance with ASTM D790-03 (“Standard Test Methods for Flexural Properties of Unreinforced and Reinforced Plastics and Electrical Insulating Materials”).

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A thermoplastic olefin composition comprising:
from about 65% to about 95% by weight of an olefin component comprising a first polypropylene homopolymer having a crystallization temperature of ≧120° C. and a flexural modulus≧300,000 psi optionally blended with a second polypropylene homopolymer having a flexural modulus<300,000 psi, provided the melt flow index ratio of the first polypropylene homopolymer to the second polypropylene homopolymer is not greater than 3:1 and the flexural modulus of the blend is ≧200,000 psi;
from about 5% to about 35% by weight of an inorganic particulate filler component; and
from about 2.5% to about 12.5% by weight of a colorant package comprising titanium dioxide and iron oxide pigments.

2. The thermoplastic olefin composition according to claim 1 wherein the inorganic particulate filler component comprises calcium carbonate.

3. The thermoplastic olefin composition according to claim 2 wherein the calcium carbonate is coated with a fatty acid.

4. The thermoplastic olefin composition according to claim 3 wherein the fatty acid is stearic acid.

5. The thermoplastic olefin composition according to claim 1 wherein the titanium dioxide comprises from about 2% to about 10% by weight of the composition and the iron oxide pigment comprises from about 0.001% to about 3% by weight of the composition.

6. The thermoplastic olefin composition according to claim 1 further comprising from about 0.05% to about 0.15% by weight of a sorbitol nucleating agent.

7. The thermoplastic olefin composition according to claim 1 further comprising from about 0.10% to about 0.20% by weight of a hindered phenolic antioxidant package.

8. The thermoplastic olefin composition according to claim 1 further comprising from about 0.01% to about 0.10% by weight of an organic phosphite process stabilizer.

9. The thermoplastic olefin composition according to claim 1 further comprising from about 0.10% to about 0.20% by weight of a calcium stearate process aid.

10. The thermoplastic olefin composition according to claim 1 further comprising from about 0.10% to about 0.20% by weight of an ethylene bis-stearamide lubricant.

11. The thermoplastic olefin composition according to claim 1 wherein the olefin component comprises from about 70% to about 80% by weight of the composition.

12. The thermoplastic olefin composition according to claim 11 wherein the weight ratio of the first polypropylene homopolymer to the second polypropylene homopolymer is from about 60:40 to 40:60.

13. The thermoplastic olefin composition according to claim 1 wherein the inorganic particulate filler component comprises from about 15% to about 35% by weight of the composition.

14. The thermoplastic olefin composition according to claim 13 wherein the inorganic particulate filler component comprises calcium carbonate.

15. The thermoplastic olefin composition according to claim 14 wherein the calcium carbonate is coated with a fatty acid.

16. The thermoplastic olefin composition according to claim 15 wherein the fatty acid is stearic acid.

17. A thermoplastic olefin composition comprising:
from about 71% to about 55% by weight of an olefin component comprising a 60:40 to a 40:60 weight ratio blend of a first polypropylene homopolymer having a crystallization temperature of ≧120° C. and a flexural modulus≧300,000 psi and a second polypropylene homopolymer having a flexural modulus<300,000 psi, provided the melt flow index ratio of the first polypropylene homopolymer to the second polypropylene homopolymer is not greater than 3:1 and the flexural modulus of the blend is ≧200,000 psi;
from about 15% to about 25% by weight of an inorganic particulate filler component comprising calcium carbonate coated with a fatty acid; and
from about 3% to about 6.5% by weight of a colorant package comprising titanium dioxide and iron oxide pigments, wherein the titanium dioxide comprises from about 2% to about 6% of the composition by weight and the iron oxide pigment comprises from about 0.01% to about 0.5% of the composition by weight.

18. The thermoplastic olefin composition according to claim 17 further comprising:
from about 0.05% to about 0.15% by weight of a sorbitol nucleating agent;
from about 0.10% to about 0.20% by weight of a hindered phenolic antioxidant package;
from about 0.01% to about 0.10% by weight of an organic phosphite process stabilizer;
from about 0.10% to about 0.20% by weight of a calcium stearate process aid; and
from about 0.10% to about 0.20% by weight of an ethylene bis-stearamide lubricant.

19. The thermoplastic olefin composition according to claim 18 wherein:
the olefin component comprises about 72.5% by weight of the composition, and comprises about a 50:50 weight ratio of the first polypropylene homopolymer and the second polypropylene homopolymer; and
the inorganic particulate filler component comprises about 20% by weight of the composition, and comprises calcium carbonate coated with stearic acid.

20. A hook portion of a hook and loop fastener formed of a thermoplastic olefin composition comprising:
from about 65% to about 95% by weight of an olefin component comprising a first polypropylene homopolymer having a crystallization temperature of ≧120° C. and a flexural modulus≧300,000 psi optionally blended with a second polypropylene homopolymer having a flexural modulus<300,000 psi, provided the melt flow index ratio of the first polypropylene homopolymer to the second polypropylene homopolymer is not greater than 3:1 and the flexural modulus of the blend is ≧200,000 psi;
from about 5% to about 35% by weight of an inorganic particulate filler component; and
from about 2.5% to about 12.5% by weight of a colorant package comprising titanium dioxide and iron oxide pigments.
